(19) United States
(12) Patent Application Publication
(10) Pub. No.: US 2010/0206536 A1
(43) Pub. Date: Aug. 19, 2010

(54) METHOD FOR PRODUCING A COMPOSITE INCLUDING AT LEAST ONE NON-FLAT COMPONENT

(76) Inventor: Claus Peter Kluge, Roslau (DE)

Correspondence Address: FULBRIGHT & JAWORSKI, LLP, 666 FIFTH AVE, NEW YORK, NY, 10103-3198, US

(21) Appl. No.: 12/596,855

(22) PCT Filed: Apr. 17, 2008
(86) PCT No.: PCT/EP08/54633

§ 371 Date: Oct. 21, 2009

(30) Foreign Application Priority Data
Apr. 24, 2007 (DE) 10 2007 019 629.8

(51) Int. Cl. F28F 7/00; B23K 31/02; B32B 37/00

(52) U.S. Cl. 165/185; 228/101; 228/256; 156/60

(57) ABSTRACT

A method for producing a composite from at least two metal components that have perforations or openings, especially for producing a cooler or cooling elements or heat sinks that have at least one composite. The components are joined to each other to yield the composite by heating them to a process temperature while using a joining agent or joining surfaces defined by surface faces of the components. To produce components having complicated geometric shapes, thereby increasing their cooling capacity, at least a first component is not flat, and is joined to at least one flat or non-flat component to yield the composite.

The invention relates to a method according to the precharacterising clause of claim 1 and to a composite produced by that method.

Especially for the cooling of electrical components or modules, in particular also those of high capacity, there are already known coolers, also known as microcoolers, which consist of thin sheets of metal (metal film) bonded together to form a stack, the sheets located inside the stack being so structured, that is to say provided with openings or perforations, that cooling channels or flow paths for a cooling medium are formed inside the stack of sheets or the cooler. For the superficial bonding of the sheets, they are provided with a joining agent on their joining surfaces, i.e. on their surface faces. For joining or bonding, the sheets are then stacked one above the other to form the stack of sheets and are then heated to an appropriate process temperature at which, using the joining agent, a molten metal region (bonding or molten layer) is produced on the joining surfaces so that, after cooling, the sheets are bonded together to form the stack of sheets.

DE 10 2004 002 841 B3 discloses a method of the generic type for producing such coolers, in which, prior to joining, the joining agent is also applied to inside surfaces of the perforations or openings.

The object underlying the invention is to develop further a method according to the precharacterising clause of claim 1 so that composites having complex geometric shapes can also be produced simply, their cooling capacity being increased as a result.

That object is achieved according to the invention in that at least one first component is not sheet-like, and this first component is bonded to at least one further, second component, which is or is not sheet-like, to form a composite. With components that are not sheet-like it is possible to produce, in a simple manner, composites of any desired geometry, so that their cooling capacity or cooling surface is accordingly increased as compared with components that are solely sheet-like.

Advantageously, a plurality of identical or different joining agents is applied to joining surfaces formed by surface faces of the components. As a result, by a suitable choice of joining agents, the nature of the bond can be adjusted in a targeted manner for the intended application.

Preferably, at least two components to be joined are of identical or different construction in terms of geometry and/or composition. A form that is identical in terms of geometry and/or composition has the advantage that, for example during rapidly changing temperatures, which can have an effect on the component, stresses in the structure are avoided in so far as the coefficients of expansion of the two components are identical. A form that is different in terms of geometry and/or composition has the advantage that, for example for particular applications, owing to the structure, sub-regions having very high and sub-regions having low thermal conductivity and/or strength and/or corrosion resistance are necessary.

At least one further component is preferably bonded with at least one surface of a component over the entire surface or over part of the surface. Any desired composites or structures can thereby be produced.

Advantageously, at least three components are bonded to form a composite.

In one embodiment, at least one or more identical or different joining agents are applied to the inside surfaces of the perforations or openings prior to the joining process. Identical joining agents have the advantage that the joining process is simple to carry out. With different joining agents, the quality of the bond can be adjusted individually. By adapting the joining agent to the components to be bonded, composites with different materials can be produced.

Preferably, at least two components are bonded together simultaneously in one process step or in a plurality of process steps. Bonding in one process step has the advantage that, for example, complex structures can be produced inexpensively. Bonding in a plurality of process steps has the advantage that it is also possible to use in succession different joining agents having very different application conditions.

In a preferred embodiment, the components are bonded together at identical or different process temperatures. The process temperatures are preferably dependent on the material of the components in the areas that are to be bonded.

In the case of components of copper or a copper alloy, CuO and/or Cu₂O is preferably used as the joining agent and joining is carried out at a process temperature in the range from 1065° C. to 1082° C.

There is advantageously used as the joining agent an alloy of Ni—P (nickel and phosphorus), for example having a phosphorus content in the range from 1 to 20 wt. %, and joining is carried out at a process temperature in the range from 850° C. to 1082° C.

In another embodiment, silver or a silver alloy is used as the joining agent and joining is carried out at a process temperature in the range from 780° C. to 1080° C.

In another embodiment, tin or a tin alloy is used as the joining agent and joining is carried out at a process temperature of from 170° C. to 280° C.

In another embodiment, glass or a mixture of glass and metals is used as the joining agent and joining is carried out at a process temperature of from 120° C. to 1100° C. Glasses act as adhesion promoter between the component and the metallic coating that is to be applied. The glass content is to be so chosen that the current-carrying ability does not fall short of the desired value.

In order that dead spots do not form in the bonding layer, after bonding, in the region of the openings and at the transition between two components, inter alia as a result of re-formation of the bonding or molten layer on cooling and/or as a result of inadequate wetting with the molten metal during joining, preferably all the components are provided with the joining agent prior to joining, at least on their joining surfaces and also at all the perforations or openings that are present.

In one embodiment, only some of the components are provided with the joining agent, prior to joining, at least on their joining surfaces and also at their perforations or openings. The surface of the original material is accordingly retained in each case on the component not provided with joining agent.

In one embodiment, only one of adjacent components is provided with the joining agent, also in the region of any openings or perforations present in that component.

The joining of at least two components preferably leads to the formation of isolated or bonded or open or partially closed or closed channel structures. This facilitates cooling of the components or composites.

The channel structures are preferably so produced that heating or cooling media can be conveyed through them and such media are, for example, air, nitrogen, water or oils.

In one embodiment, the joining of at least two components creates an assembly surface with the aid of which the composite can be bonded to a superposed system. Bonds can be, for example, clamping, riveting, screwing or soldering. Superposed systems can be, for example, housings.

Advantageously, individual components and/or the composite is/are bonded over their entire surface or over part of their surface with electrically and/or thermally conducting tracks.

Advantageously, individual components and/or the composite is/are bonded to active or passive electrical or electronic components.

Preferably, prior to the joining process, the components of metal are bonded to a support body, the support body being electrically non-conducting or virtually non-conducting and being provided in one piece with cooling elements that dissipate or supply heat, and the support body and/or the cooling element consisting of at least one ceramics component or of a composite of different ceramics.

One-piece support bodies having cooling elements are described, for example, in DE 10 2007 014433 A1 .

A composite produced by the method according to the invention is preferably a ceramics heat sink.

A heat sink is understood as being a support body for electrical or electronic structural elements or circuits, the support body being electrically non-conducting or virtually non-conducting and the support body being provided in one piece with cooling elements that dissipate or supply heat. Preferably, the support body is a plate and the cooling elements are bores, channels, ribs and/or recesses to which a heating or cooling medium can be applied. The support body and/or the cooling element consist, for example, of at least one ceramics component or of a composite of different ceramics.

1. A method for producing a composite of at least two components made of metal and provided with perforations or openings, in particular for producing coolers or cooler elements or heat sinks comprising at least one composite, wherein the components are bonded together to form the composite using a joining agent on joining surfaces formed by surface faces of the components by heating to a process temperature, wherein at least one first component is not sheet-like, and that first component is bonded to at least one further, second component, which is or is not sheet-like, to form a composite.

2. A method according to claim 1, wherein a plurality of identical or different joining agents are applied to joining surfaces formed by surface faces of the components.

3. A method according to claim 1, wherein at least two components to be joined are of identical or different construction in terms of geometry or composition.

4. A method according to claim 1, wherein at least one further component is bonded to at least one surface of a component over the entire surface or over part of the surface.

5. A method according to claim 1, wherein at least three components are bonded to form a composite.

6. A method according to claim 1, wherein, prior to the joining process, at least one or more identical or different joining agents are applied to the inside surfaces of the perforations or openings.

7. A method according to claim 1, wherein at least two components are bonded together simultaneously in one process step or in a plurality of process steps.

8. A method according to claim 7, wherein the components are bonded together at identical or different process temperatures.

9. A method according to claim 1, wherein, in the case of components of copper or a copper alloy, CuO or Cu₂O is used as the joining agent and joining is carried out at a process temperature in the range from 1065° C. to 1082° C.

10. A method according to either claim 1, wherein there is used as the joining agent an alloy of Ni—P, for example having a phosphorus content in the range from 1 to 20 wt. %, and joining is carried out at a process temperature in the range from 850° C. to 1082° C.

11. A method according to claim 1, wherein silver or a silver alloy is used as the joining agent and joining is carried out at a process temperature in the range from 780° C. to 1080° C.

12. A method according to claim 1, wherein tin or a tin alloy is used as the joining agent and joining is carried out at a process temperature of from 170° C. to 280° C.

13. A method according to claim 1, wherein glass or a mixture of glass and metals is used as the joining agent and joining is carried out at a process temperature of from 120° C. to 1100° C.

14. A method according to claim 1, wherein, prior to joining, all the components are provided with the joining agent at least on their joining surfaces and also at all the perforations or openings that are present.

15. A method according to claim 1, wherein, prior to joining, only some of the components are provided with the joining agent at least on their joining surfaces and also at their perforations or openings.

16. A method according to claim 1, wherein in each case only one of adjacent components is provided with the joining agent, also in the region of any openings or perforations present in that element.

17. A method according to claim 1, wherein isolated or bonded or open or partially closed or closed channel structures are formed by the joining of at least two components.

18. A method according to claim 17, wherein heating or cooling media can be conveyed through the channel structures and those media are air, nitrogen, water or oils.

19. A method according to claim 1, wherein, by joining at least two components, an assembly surface is created, with the aid of which the composite can be bonded to a superposed system.

20. A method according to claim 1, wherein individual components or the composite is bonded over their entire surface or over part of their surface to electrically or thermally conducting tracks.

21. A method according to claim 1, wherein individual components or the composite is bonded to active or passive electrical or electronic components.

22. A method according to claim 1, wherein, prior to the joining process, the components of metal are bonded to a support body, the support body being electrically non-conducting or virtually non-conducting and being provided in one piece with cooling elements that dissipate or supply heat, and the support body or the cooling element comprising at least one ceramics component or of a composite of different ceramics.

23. A composite produced by a method according to claim 22, wherein the composite is a ceramics heat sink.
